(19) United States
(12) Patent Application Publication
(10) Pub. No.: US 2016/0347301 A1
(43) Pub. Date: Dec. 1, 2016

(54) Bleed Valves and Bleed Valve Assemblies

(71) Applicant: SRAM, LLC, Chicago, IL (US)

(72) Inventor: Paul D. Gallagher, Taichung City (TW)

(73) Assignee: SRAM, LLC, Chicago, IL (US)

(21) Appl. No.: 14/722,216

(22) Filed: May 27, 2015

(51) Int. Cl. B60T 17/22; F16L 29/02; F16L 21/08

(52) U.S. Cl. CPC B60T 17/222; F16L 21/08; F16L 29/02

(57) ABSTRACT

A bleed valve includes an exterior surface, a socket defining a space, and a fluid flow passageway extending from the exterior surface to the space.

### BACKGROUND OF THE INVENTION

A traditional hydraulic system is bled to remove air from the hydraulic system and/or replace fluid in the hydraulic system. Typically, the hydraulic system includes a plug that must be removed and replaced with a bleed fitting. During removal of the plug and installation of the bleed fitting, air is often introduced into the hydraulic system and/or hydraulic fluid spills out of the hydraulic system.

### SUMMARY

According to one aspect, a bleed valve assembly includes a bleed valve having a first fluid flow passageway and a socket in fluid communication with the first fluid flow passageway. The bleed valve assembly also includes a male coupling. The male coupling includes a first tube having a second fluid flow passageway. The first tube is dimensioned to be received in the socket of the bleed valve to enable the second fluid flow passageway to be in fluid communication with the first fluid flow passageway. The male coupling also includes a key to be received in the socket to rotatably lock the male coupling to the bleed valve.

According to another aspect, a bleed valve includes an exterior surface, a socket defining a space, and a fluid flow passageway extending from the exterior surface to the space.

According to a different aspect, a bleed valve assembly includes a housing including a receptacle and a first fluid flow passageway in fluid communication with the receptacle. The bleed valve assembly also includes a bleed valve to be disposed in the receptacle and movably coupled to the housing. The bleed valve includes a plug, a second fluid flow passageway, and a socket in fluid communication with the second fluid flow passageway.

According to another aspect, a bleed valve assembly includes a bleed valve having a socket and a first fluid flow passageway in fluid communication with the socket. The bleed valve assembly further includes a male coupling including a second fluid flow passageway, first tube, a hose connector, and knob. The first tube is to be received in the socket to fluidly couple the first fluid flow passageway and the second fluid flow passageway.

### BRIEF DESCRIPTION OF THE DRAWINGS

FIG. 1 is a side elevational view of a bicycle, which may employ a bleed valve assembly disclosed herein;

FIG. 2 is a perspective cross-sectional view of a brake caliper including a bleed valve, which may be used to implement the bicycle of FIG. 1;

FIG. 3 is a perspective cross-sectional view of the brake caliper of FIG. 2 including a brake line fitting;

FIG. 4 is a side view of the bleed valve of FIG. 2;

FIG. 5 is a cross-sectional view of the bleed valve of FIGS. 2 and 4 taken along line 5-5 of FIG. 4;

FIG. 6 is a top, perspective view of the bleed valve of FIGS. 2-5;

FIG. 7 is a top plan view of the bleed valve of FIGS. 2-6;

FIG. 8 is an enlarged, cross-sectional view of the bleed valve of FIGS. 2-7 received in a receptacle of the brake caliper of FIG. 2;

FIG. 9 is a cross-sectional view of the bleed valve and brake caliper of FIG. 8 illustrating a cap coupled to the bleed valve;

FIG. 10 is a bottom perspective view of a male coupling in accordance with the teachings of this disclosure;

FIG. 11 is a front top view of the male coupling of FIG. 10;

FIG. 12 is a cross-sectional view of the male coupling of FIGS. 10 and 11 taken along line 12-12 of FIG. 11;

FIG. 13 is a cross-sectional view of the male coupling of FIGS. 10-12 received in a socket of the bleed valve of FIGS. 2-9, where the bleed valve is in a closed position; and

FIG. 14 is a cross-sectional view of the male coupling of FIGS. 10-13 received in the socket of the bleed valve of FIGS. 2-9 and 13, where the bleed valve is in an open position.

Other aspects and advantages of the embodiments disclosed herein will become apparent upon consideration of the following detailed description, wherein similar or identical structures have similar or identical reference numerals.

### DETAILED DESCRIPTION

Bleed valve assemblies disclosed herein enable a component of a hydraulic system to be bled efficiently, without spillage of hydraulic fluid, and/or without the introduction of air into the hydraulic system. A bleed valve assembly in accordance with the teachings of this disclosure may include a housing having a receptacle, a bleed valve received in the receptacle, and a male coupling to move the bleed valve from a closed position to an open position. For example, the bleed valve may have external threads engaging internal threads of the receptacle of the housing. When the bleed valve is in a closed position, the bleed valve plugs a first fluid flow passageway in the housing. The bleed valve may have a socket with a keyed section, and the male coupling may include a tube and a key. To bleed the component of the hydraulic system, the tube and the key are inserted into the socket of the bleed valve. As a result, the key engages the keyed section of the socket. When the male coupling rotates in a first direction, the bleed valve rotates in the first direction and moves from the closed position to the open position, unplugging the first fluid flow passageway of the housing.

In some embodiments, the bleed valve includes a second fluid flow passageway in fluid communication with the receptacle of the housing and the socket of the bleed valve. The tube of the male coupling may include a third fluid flow passageway. Thus, when the bleed valve is in the open position, fluid in the first fluid flow passageway of the housing flows into the socket of the bleed valve via the second fluid flow passageway. Then, the fluid in the socket flows into the third fluid flow passageway of the male coupling and out of the hydraulic system. In some embodiments, the male coupling includes a hose connector, and a hose is coupled to the hose connector. In other embodiments, a vacuum is operatively coupled to the hose to generate a vacuum and draw the fluid out of the hydraulic system via the male coupling.

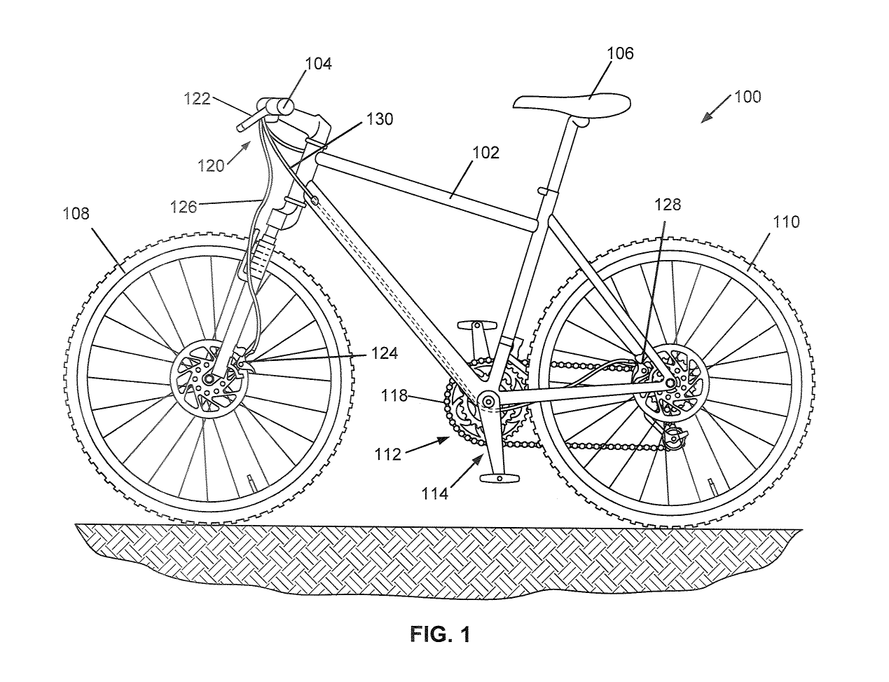

FIG. 1 illustrates an example bicycle 100, which may be used to implement the bleed valve assemblies disclosed herein. In the illustrated embodiment, the bicycle 100 includes a frame 102, handle bars 104, and a seat 106. The bicycle 100 also includes a first or front wheel 108 and a second or rear wheel 110. The bicycle 100 includes a drive train 112. The drive train 112 of FIG. 1 includes a crank assembly 114 operatively coupled to a rear cassette (not shown) via a chain 118. While the illustrated bicycle 10 is a mountain bike, the present invention has applications to bicycles of any type, including road bikes and others, as well as bicycles with mechanical (e.g. cable, hydraulic, pneumatic) and non-mechanical (e.g. wired, wireless) drive systems.

The bicycle 100 of FIG. 1 includes a hydraulic brake system 120. In the illustrated embodiment, the hydraulic brake system 120 includes a first brake lever assembly 122 and a second brake lever assembly (not shown). The first brake lever assembly 122 and the second brake lever assembly are disposed on the handlebars 104. The first brake lever assembly 122 is hydraulically coupled to a first brake caliper 124 via a first brake line 126. In the illustrated embodiment, the first brake caliper 124 is operatively coupled to the front wheel 108. The second brake lever assembly is operatively coupled to a second brake caliper 128 via a second brake line 130. The second brake caliper 128 is operatively coupled to the rear wheel 110. In other embodiments, the hydraulic brake system 120 includes one or more additional and/or alternative components and/or is configured in other ways.

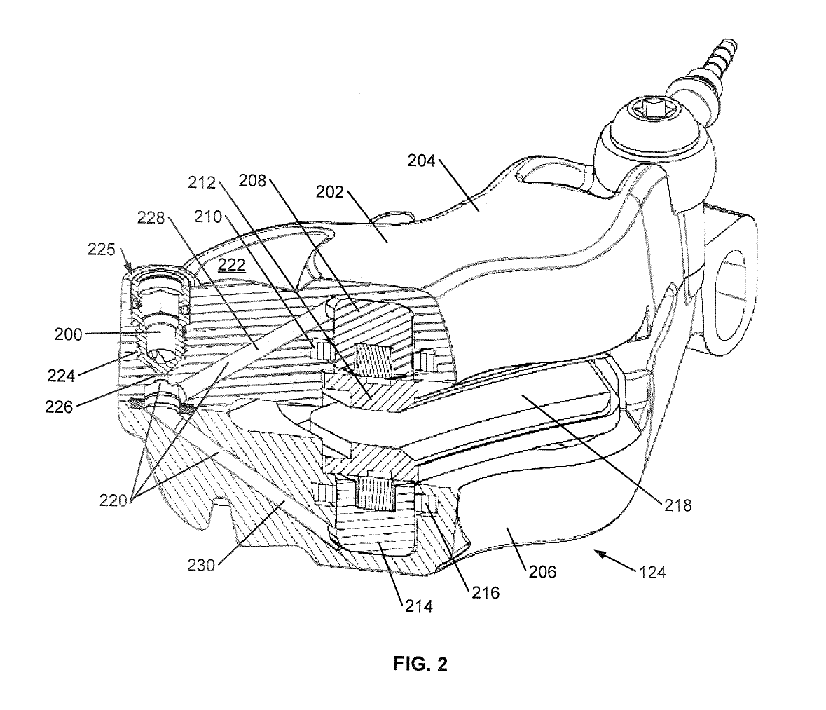

FIG. 2 is a cross-sectional view of the first brake caliper 124 of FIG. 1 employing a bleed valve 200 in accordance with the teachings of this disclosure. Although the bleed valve 200 is described below in conjunction with the first brake caliper 124, the bleed valve 200 may be employed with any component of the hydraulic brake system 120 of the bicycle of FIG. 1 having a fluid flow passageway conveying hydraulic fluid. For example, the bleed valve 200 may be employed with the second brake caliper 128, the first brake lever assembly 122, the second brake lever assembly, and/or any other component of the hydraulic brake system 120 having a fluid flow passageway conveying brake fluid. The bleed valve 200 may also be used in other bicycle components such as a brake lever assembly, rim brakes or a suspension system. Further, the bleed valve 200 may also be employed with any other hydraulic system such as, for example, a hydraulic brake system of a motorcycle, a hydraulic brake system of an automobile, a hydraulic system of an airplane, a hydraulic system of a machine (e.g., a hydraulic machine press), a hydraulic system employing a hydraulic motor, a hydraulic circuit of a process control system, and/or any other type of hydraulic system.

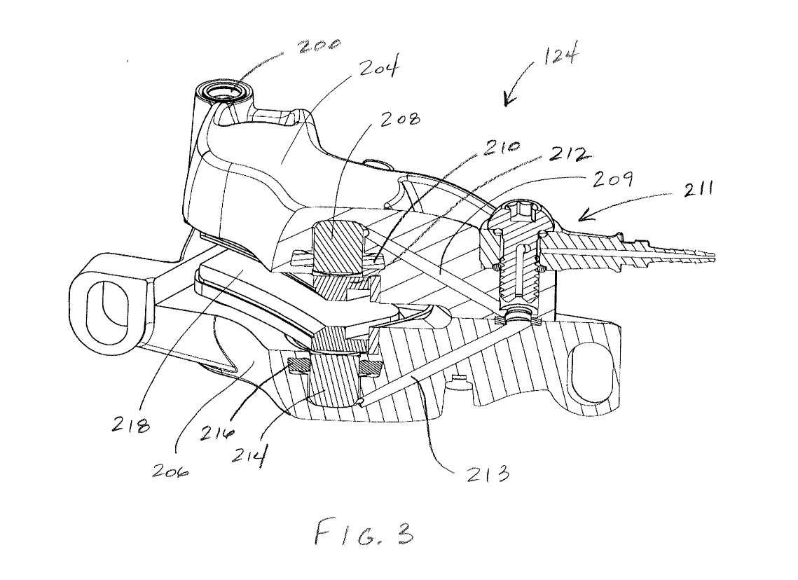

In the illustrated embodiment, the first brake caliper 124 includes a housing 202 having a first section 204 and a second section 206 coupled to the first section 204. A first piston 208 (e.g., a slave piston) is operably coupled to the first section 204 via a first piston seal 210. A first brake pad 212 is coupled to the first piston 208. A second piston 214 (e.g., a slave piston) is operably coupled to the second section 206 via a second piston seal 216. A second brake pad 218 is coupled to the second piston 214. Referring to FIG. 3, the first piston 208 and the second piston 214 are hydraulically coupled to a master cylinder (not shown) of the first brake lever assembly 122 via a fourth fluid flow passageway 209 and a fifth fluid low passageway 213, respectively. The fourth and fifth fluid flow passageways 209, 213 are in fluid communication with a brake line fitting 211 which is connected to the first brake line 1226 extending between the first brake caliper 124 and the first brake lever assembly 122. When a user actuates the first brake lever assembly 122, the master cylinder increases a pressure of fluid in the fourth and fifth fluid flow passageway 209, 213. As a result, the first piston 208 and the second piston 214 move toward each other and, thus, the first brake pad 212 and the second brake pad 218 move toward each other to engage a rotor 107 and apply a braking force to the front wheel 108.

The bleed valve 200 of FIG. 2 is employed by the hydraulic brake system 120 of FIG. 1 to enable a technician to efficiently bleed a portion of the hydraulic brake system 120 without spilling substantially any hydraulic fluid and without introducing air into the hydraulic brake system 120. The hydraulic brake system 120 may also be bled to replace hydraulic fluid employed by the hydraulic brake system 120 and/or remove air from the hydraulic brake system 120.

In the illustrated embodiment, the first section 204 of the housing 202 of the first caliper 124 has an aerodynamic surface 222. As used in this disclosure, an aerodynamic surface is a surface of a vehicle on which air generates an aerodynamic force (e.g., lift, down force, drag, etc.) when the vehicle is in motion. The bleed valve 200 of FIG. 2 is received in a receptacle 224 of the first section 204 of the housing 202. The aerodynamic surface 222 of FIG. 2 defines an opening 225 of the receptacle 224. In the illustrated embodiment, a first branch 226 of the first fluid flow passageway 220 meets or opens into the receptacle 224. The first branch 226 is in fluid communication with a second branch 228 and a third branch 230 of the first fluid flow passageway 220. The second branch 228 is in direct fluid communication with the first piston 208. The third branch 230 is in direct fluid communication with the second piston 214. As described in greater detail below, when the bleed valve 200 is disposed in a first or closed position within the receptacle 224 of the housing 202, an end of the bleed valve 200 is substantially flush with or recessed relative to a portion of the aerodynamic surface 222 adjacent to and/or surrounding the receptacle 224. As a result, the bleed valve 200 does not compromise aerodynamic characteristics and/or performance of the housing 202. For example, unlike traditional bleed valves that protrude from a surface and generate additional drag, the bleed valve 200 of FIG. 2 is substantially flush with, forms a portion of, and/or is recessed relative to the portion of the aerodynamic surface 222 adjacent to and/or surrounding the opening 225 of the receptacle 224. As a result, the bleed valve 200 generates substantially no additional drag on the housing 202 relative to the aerodynamic surface 222.

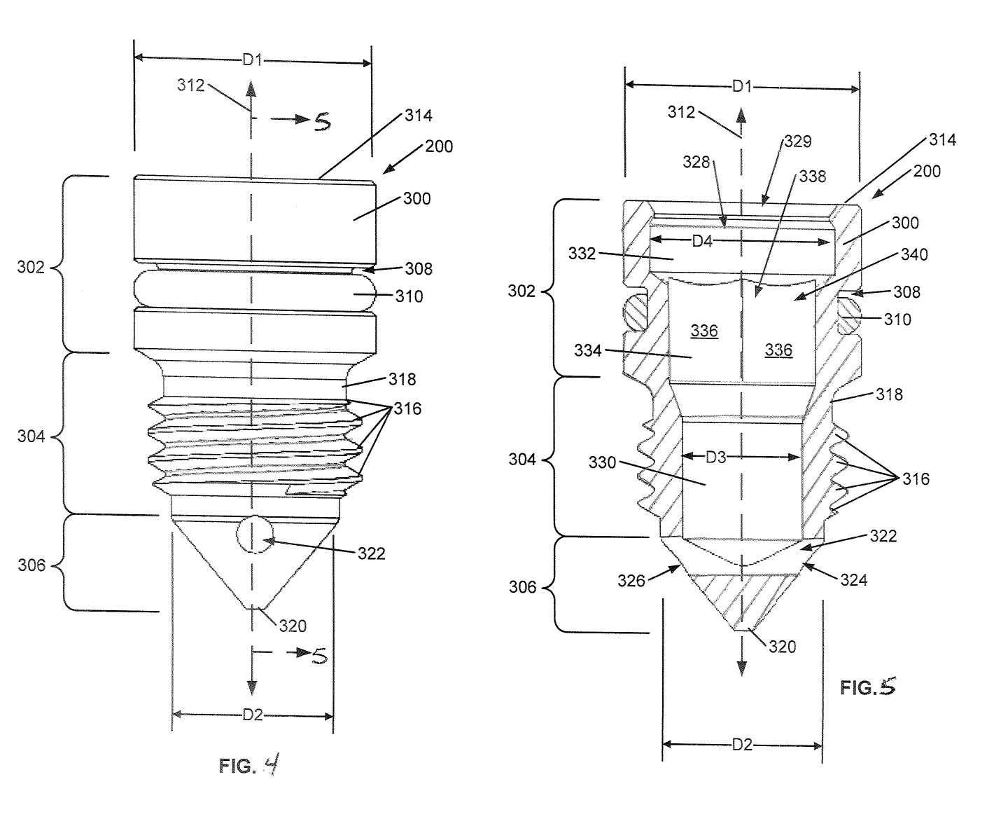

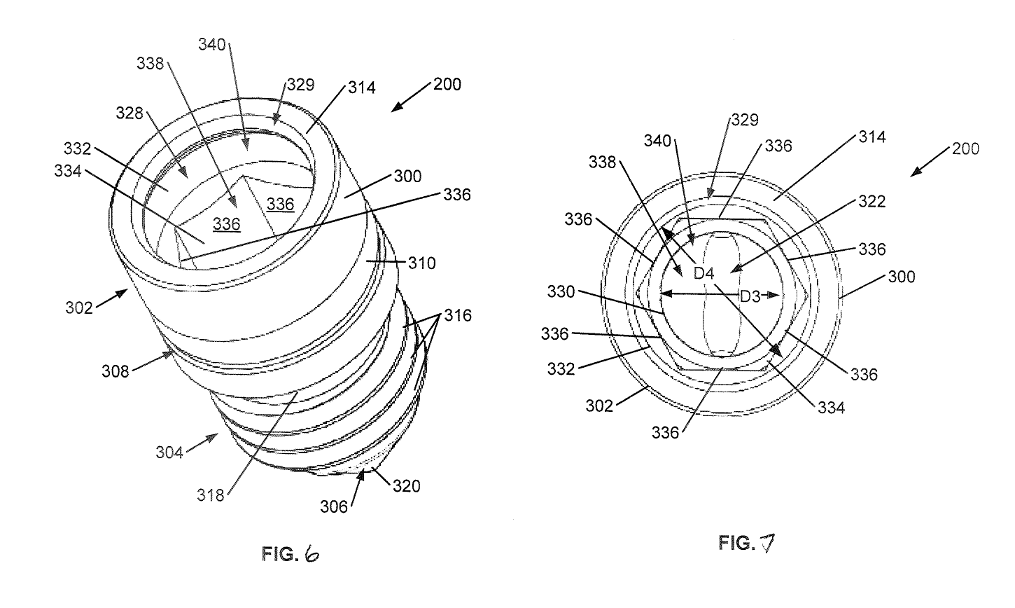

FIGS. 4-7 illustrate the bleed valve 200 of FIG. 2. Referring to FIGS. 4 and 5, the bleed valve 200 includes a body 300 having a head 302, a neck 304, and a nose 306. The head 302 of the bleed valve 200 is substantially cylindrical and includes a circumferential channel or groove 308. A first O-ring 310 is seated in the groove 308. As described in greater detail below, when the bleed valve 200 is operatively coupled to the housing 202 of the first caliper 124, the first O-ring 310 forms a fluid seal between the body 300 of the bleed valve 200 and the housing 202. The head 302 has a first outer diameter D1 taken substantially perpendicular to a longitudinal axis 312 of the bleed valve 200. The head 302 defines a first end 314 of the bleed valve 200, which may be accessible to a user (e.g., a technician) when the bleed valve 200 is received in the housing 202 of the first caliper 124. In some embodiments, the head 302 is not cylindrical. For example, the head 302 may be tapered, stepped, and/or have a cross-sectional shape taken perpendicular to the longitudinal axis 312 that is non-circular (e.g., polygonal). In such embodiments, the first outer diameter D1 is a smallest diameter of a circle that circumscribes outermost points of the head 302 and lies in a plane perpendicular to the longitudinal axis 312.

Referring to FIG. 4, in the illustrated embodiment, the neck 304 extends from the head 302. The neck 304 is cylindrical and has a second outer diameter D2 taken substantially perpendicular to the longitudinal axis 312 of the bleed valve 200. In the illustrated embodiment, the second outer diameter D2 is less than the first outer diameter D1. In other embodiments, the first outer diameter D1 is substantially the same as the second outer diameter D2. In some embodiments, the neck 304 is not cylindrical. For example, the neck 304 may be tapered, stepped, and/or have a cross-sectional shape taken perpendicular to the longitudinal axis 312 that is non-circular (e.g., polygonal). In such embodiments, the second outer diameter D2 is a smallest diameter of a circle that circumscribes outermost points of the neck 304 and lies in a plane perpendicular to the longitudinal axis 312. The neck 304 of FIG. 4 includes a plurality of threads 316. In the illustrated embodiment, the threads 316 are male threads and, thus, the threads 316 extend outward (i.e., away from the longitudinal axis 312) from an exterior surface 318 along the neck 304 of the body 300. In other embodiments, the threads 316 are female threads and are recessed relative to the exterior surface 318 of the body 300. In some embodiments, one or more additional and/or alternative portions of the body 300 includes one or more threads. For example, the head 302 may include one or more threads. As described in greater detail below, the threads 316 movably couple the bleed valve 200 to the housing 202 of the first caliper 124.

In the illustrated embodiment, the nose 306 defines a second end 320 of the bleed valve 200 opposite the first end 314. In the illustrated embodiment, the nose 306 is tapered and/or converges toward the second end 320. In some embodiments, the nose 306 is frustoconical-shaped. In other embodiments, the nose 306 is other shapes. As described in greater detail below, the nose 306 plugs the first branch 226 of the first fluid flow passageway 220 when the bleed valve 200 is in the first or closed position.

Still referring to FIG. 4, The bleed valve 200 includes a second fluid flow passageway 322. In the illustrated embodiment, the second fluid flow passageway 322 extends substantially perpendicular to the longitudinal axis 312 of the bleed valve 200. The second fluid flow passageway 322 is disposed between the first end 314 and the second end 320. More specifically, in the illustrated embodiment, the second fluid flow passageway 322 is disposed between the threads 316 and the second end 320. In other embodiments, the second fluid flow passageway 322 has other orientations and/or configurations.

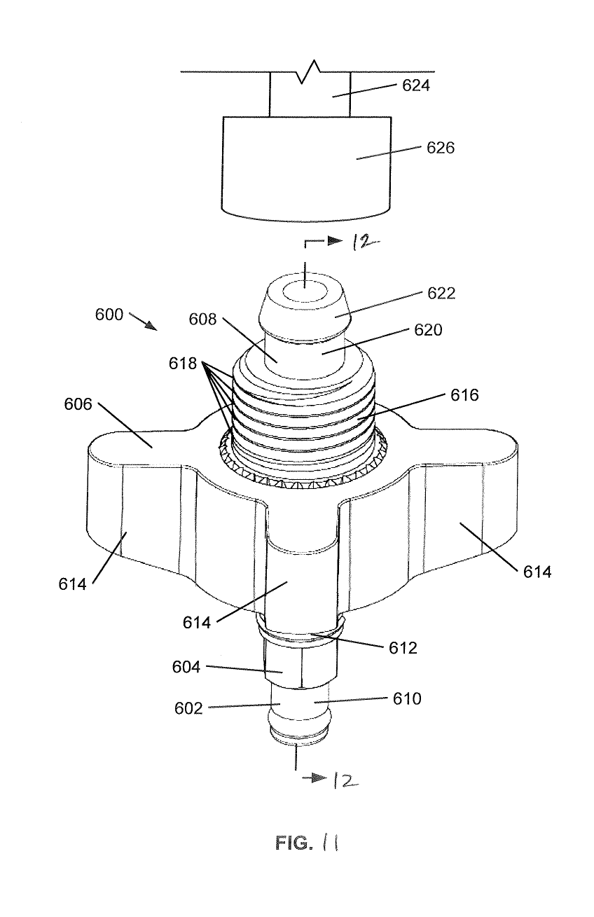

Referring to FIG. 5, in the illustrated embodiment, the second fluid flow passageway 322 extends through the body 300. Thus, the body includes a first port 324 and a second port 326. In the illustrated embodiment, the bleed valve 200 includes a female receptacle or socket 328. The socket 328 extends from the first end 314 of the bleed valve 200 to the second fluid flow passageway 322. Thus, the second fluid flow passageway 322 intersects the socket 328 and is in fluid communication with the first port 324, the second port 326, and the socket 328. In the illustrated embodiment, the first end 314 defines an opening 329 of the socket 328. As described in greater detail below, the socket 328 receives a male coupling 600 (FIGS. 10-14) via the opening 329.

In the illustrated embodiment, the socket 328 includes a first cylindrical bore 330, a second cylindrical bore 332, and a keyed section 334 disposed between the first cylindrical bore 330 and the second cylindrical bore 332. The first cylindrical bore 330 has a first inner diameter D3 taken substantially perpendicular to the longitudinal axis 312. The second cylindrical bore 332 has a second inner diameter D4 taken substantially perpendicular to the longitudinal axis 312. In the illustrated embodiment, the first inner diameter D3 is less than the second inner diameter D4. In some embodiments, the first bore 330 and/or the second bore 332 are not cylindrical. For example, the first bore 330 and/or the second bore 332 may be tapered, stepped, and/or have cross-sectional shapes taken perpendicular to the longitudinal axis 312 that are non-circular (e.g., polygonal). In such embodiments, the first inner diameter D3 is a largest diameter of a circle that inscribes the socket 328 within the first bore 330 and lies in a plane perpendicular to the longitudinal axis 312; the second inner diameter D4 is a largest diameter of a circle that inscribes the socket 328 within the second bore 332 and lies in a plane perpendicular to the longitudinal axis 312.

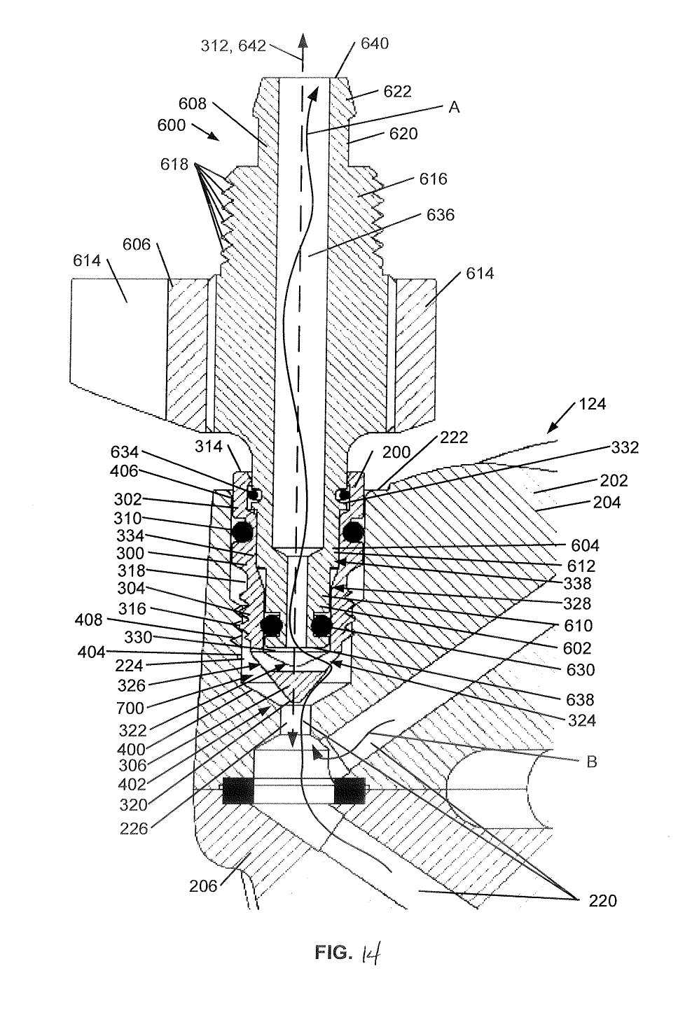

As illustrated in FIG. 7, the keyed section 334 of FIG. 5 includes six substantially planar walls 336 forming a polygonal shaped female receptacle 338. The polygonal shaped female receptacle 338 of FIG. 5 is hexagonal. In other embodiments, the keyed section 334 has one or more walls forming other non-cylindrical shaped female receptacles (e.g., rectangular, octagonal, triangular, starred, T-shaped, etc.). In the illustrated embodiment, the first cylindrical bore 330, the second cylindrical bore 332, and the keyed section 334 are substantially concentric. The socket 328 defines a space 340 to receive a portion of the male coupling 600 as illustrated in FIGS. 13 and 14.

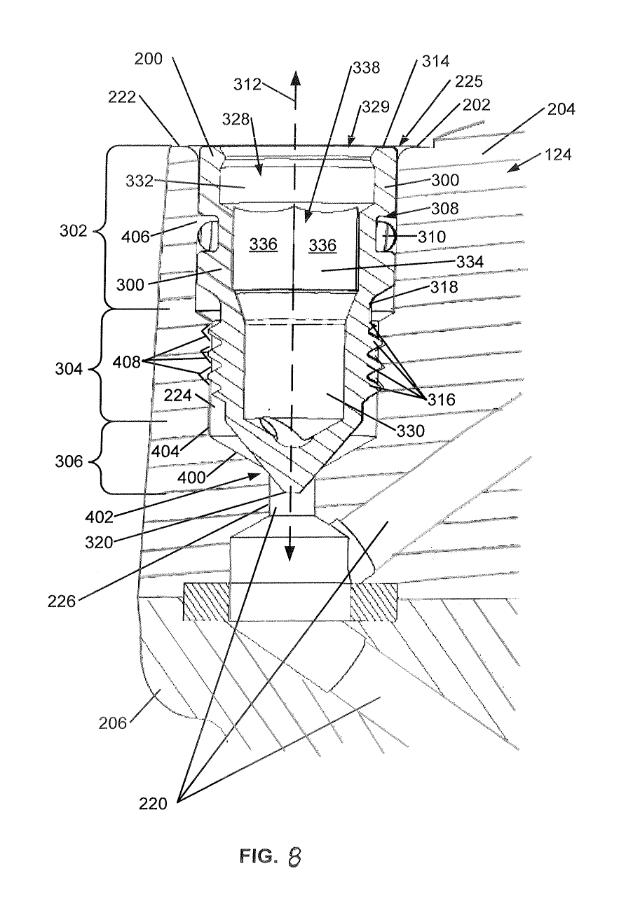

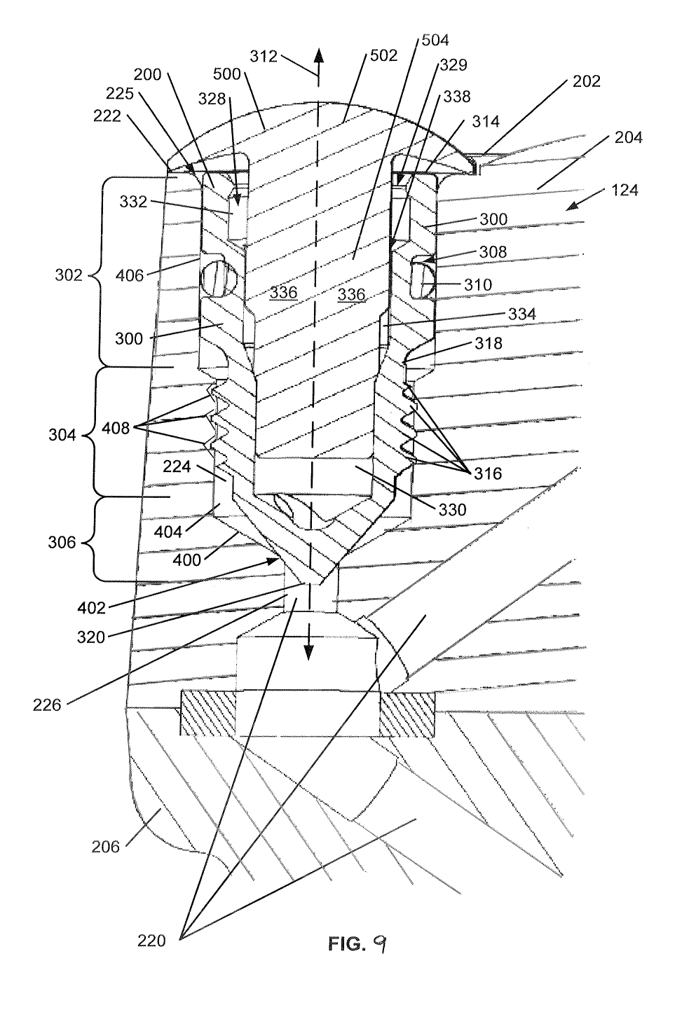

FIG. 8 is a cross-sectional view of the first caliper 124 illustrating the bleed valve 200 in the first or closed position. In the illustrated embodiment, the nose 306 is a plug. For example, when the bleed valve 200 is in the closed position, the nose 306 of the bleed valve 200 contacts a seat 400 at or near a junction 402 of the receptacle 224 and the first branch 226 of the first fluid flow passageway 220 to form a fluid seal between the nose 306 and the housing 202. As a result, the bleed valve 200 prevents fluid from flowing from the first branch 226 into the receptacle 224. Thus, the receptacle 224 is not in fluid communication with the first fluid flow passageway 220 when the bleed valve 200 is in the closed position. The bleed valve 200 is in the closed position when the brake system 120 is not being bled (e.g., when the bicycle 100 is being ridden). In the illustrated embodiment, when the bleed valve 200 is in the closed position, the first end 314 of the body 300 is substantially flush with a portion of the surface 222 of the first section 204 of the housing 202 adjacent to and/or surrounding the first end 314 of the body. In other embodiments, the first end 314 is recessed relative to the portion of the surface 222 adjacent to and/or surrounding the first end 314 of the body when the bleed valve 200 is in the closed position. As a result, the bleed valve 200 does not compromise aerodynamic characteristics and/or performance of the housing 202. For example, the bleed valve 200 generates substantially no additional drag on the housing 202 relative to the aerodynamic surface 222.

The receptacle 224 includes a bore 404 extending from the seat 400. A counter bore 406 extends from the bore 404 to the surface 222. In the illustrated embodiment, the head 302 of the bleed valve 200 is received in the counter bore 406, and the neck 304 of the bleed valve 200 is received in the bore 404. The first O-ring 310 forms a fluid seal between the bleed valve 200 and the housing 202 within the counter bore 406. The bore 404 of the receptacle 224 includes threads 408 to engage the threads 316 of the bleed valve 200. In the illustrated embodiment, the threads 408 are female threads (i.e., recessed or grooved threads) and the threads 316 are male threads. In other embodiments, the threads 408 are male threads, and the threads 316 are female threads. In the illustrated embodiment, the seat 400 is a tapered portion of the receptacle 224 that extends from the bore 404 and converges toward the first branch 226.

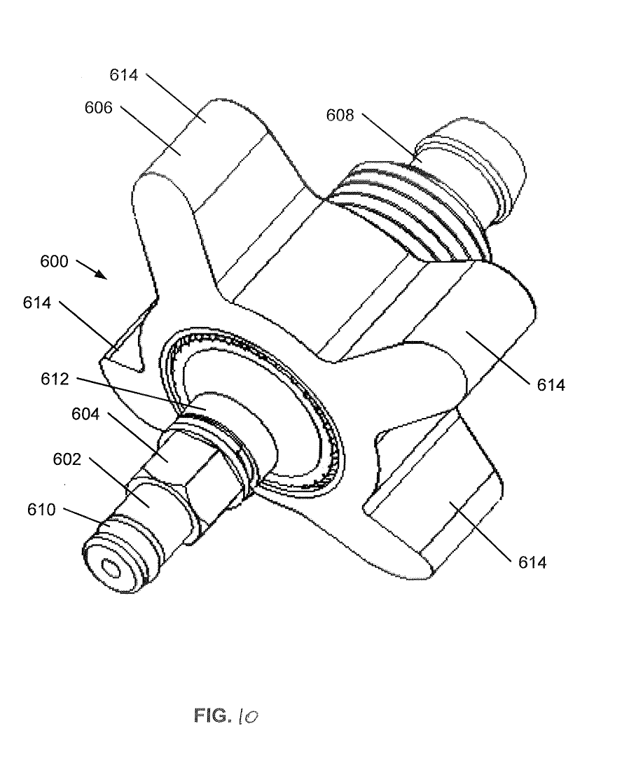

FIG. 9 is a cross-sectional view of the first caliper 124 and the bleed valve 200 illustrating a cap 500 coupled to the bleed valve 200. In the illustrated embodiment, the cap 500 includes a head 502 substantially covering the socket 328. The cap 500 also includes a plug 504 received in portions of the first cylindrical bore 330, the keyed section 334, and the second cylindrical bore 332 of the socket 328. The cap 500 substantially prevents debris from entering and/or residing in the socket 328. In some embodiments, the cap 500 is snap-fit into the socket 328. In other embodiments, the cap 500 is coupled to the bleed valve 500 and/or the housing 202 in other ways.

FIG. 10 is a bottom, perspective view of a male coupling 600 in accordance with the teachings of this disclosure. When the brake system 120 is bled via the bleed valve 200, the male coupling 600 fluidly couples the bleed valve 200 to a vacuum and/or a drain to facilitate bleeding of the brake system 120 without introducing air into the brake system 120 and/or without spilling or leaking fluid. In the illustrated embodiment, the male coupling 600 includes a first tube 602, a key 604, a knob 606, and a hose connector 608. The first tube 602 includes a first section 610 and a second section 612. In the illustrated embodiment, the key 604 is disposed on the first tube 602 between the first section 610 and the second section 612. The knob 606 is disposed between or interposes the first tube 602 and the hose connector 608.

The first section 610 of the first tube 602 is shaped and dimensioned to be received in the first cylindrical bore 330 of the socket 328 of the bleed valve 200. In the illustrated embodiment, the first section 610 of the first tube 602 is cylindrical. The key 604 of FIG. 10 is shaped and dimensioned to engage or mate with the keyed section 334 of the socket 328. For example, in the illustrated embodiment, the key 604 is a hexagonal prism. In other embodiments, the key 604 has other shapes and/or configurations. The second section 612 of the first tube 602 is shaped and dimensioned to be received in the second cylindrical bore 332. For example, the second section 612 is cylindrical.

The knob 606 of FIG. 10 includes four protrusions or handles 614 to facilitate gripping and/or rotating of the male coupling 600 by a hand of a user such as, for example, a technician. In other embodiments, the knob 606 is configured in other ways. For example, the knob 606 may include other numbers of the protrusions 614 (e.g., 1, 2, 3, 5, etc.), the protrusions 614 may be one or more different shapes and/or sizes than illustrated in FIG. 10 to facilitate gripping of the knob 606 by a hand, the knob 606 may be sized and shaped to facilitate gripping and/or rotating of the male coupling 600 via a tool (e.g., a wrench), and/or the knob 606 may be configured in one or more additional and/or alternative ways.

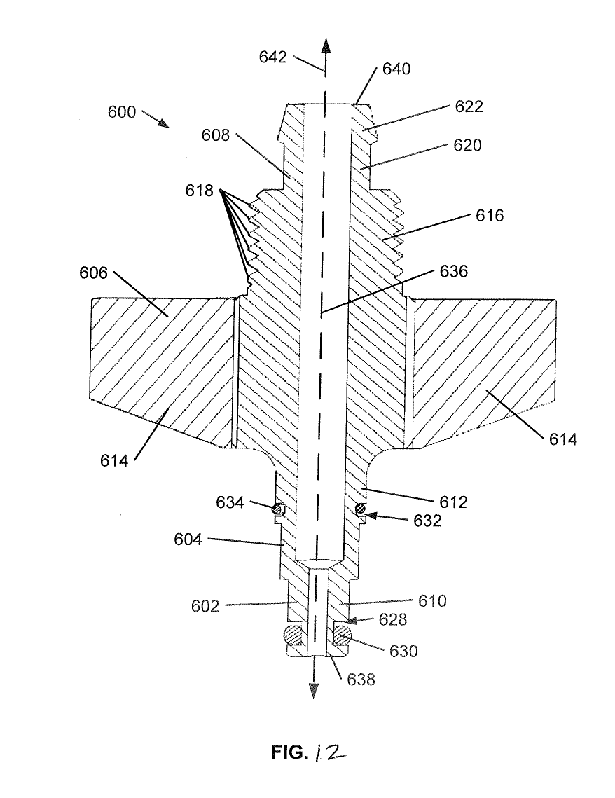

FIG. 11 is a front and top view of the male coupling 600 of FIG. 10. In the illustrated embodiment, the hose connector 608 includes a collar 616 having male threads 618. A second tube 620 extends from the collar 602. In the illustrated embodiment, the second tube 620 includes a barbed tip 622 to engage a hose 624. As described in greater detail below, the hose 624 may be operatively coupled to a vacuum (not shown) to draw fluid from the brake system 120 via the male coupling 600. In the illustrated embodiment, the hose 622 includes a female connector 626 having internal threads (not shown) to engage the threads 618 of the collar 616 and secure the hose 624 to the male coupling 600.

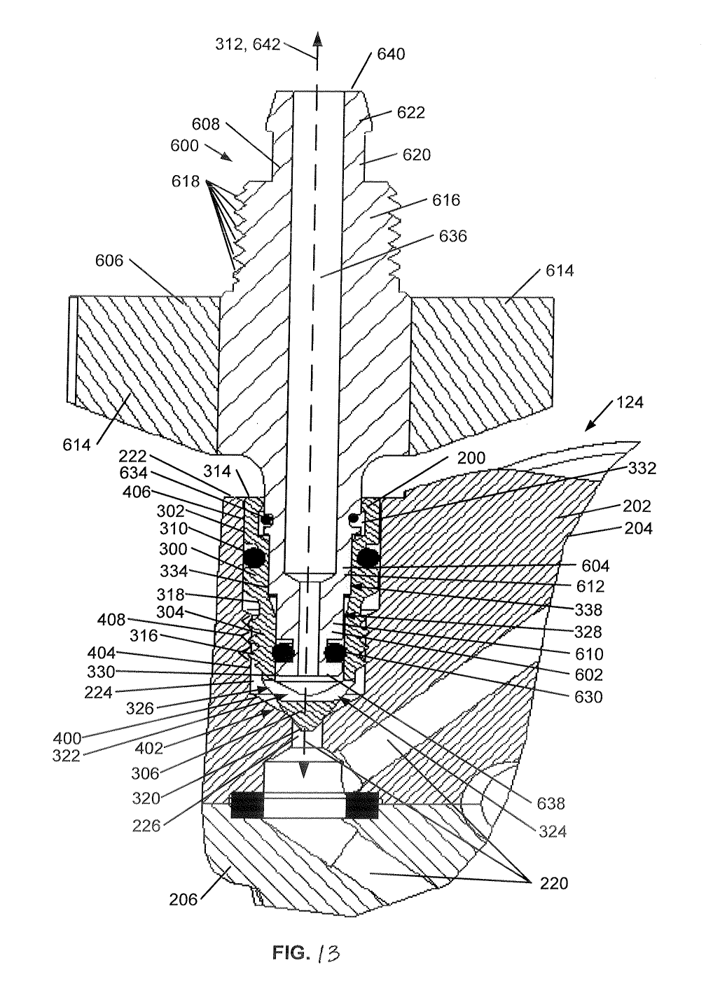

FIG. 12 is a cross-sectional view of the male coupling 600 of FIGS. 10 and 11 along line 12-12 of FIG. 11. In the illustrated embodiment, the first section 610 of the first tube 602 includes a first groove or channel 628. A first O-ring 630 is disposed in the first groove 628. The second section 612 of the first tube 602 includes a second groove or channel 632. A second O-ring 634 is disposed in the second groove 632. As described in greater detail below, the first O-ring 630 and the second O-ring 634 form fluid seals between the male coupling 600 and the socket 328 of the bleed valve 200.

In the illustrated embodiment, the male coupling 600 includes a third fluid flow passageway 636. The third fluid flow passageway 636 extends from a first end 638 of the male coupling 600 to a second end 640 of the coupling opposite the first end 638. In the illustrated embodiment, the third fluid flow passageway 636 extends through the first tube 602, the knob 606, and the hose connector 608 along a longitudinal axis 642. Thus, the third fluid flow passageway 636 extends through the male coupling 600. In other embodiments, the third fluid flow passageway 636 is configured in other ways.

FIG. 13 is a cross-sectional view of the male coupling 600 engaging the bleed valve 200. To engage or disengage the male coupling 600 from the bleed valve 200, the male coupling 600 may translate or slide relative to the bleed valve 200 along the longitudinal axis 312 of the bleed valve 200. Thus, the first tube 602 and the key 604 of the male coupling 600 may be quickly and easily inserted into the bleed valve 200 to operatively couple the male coupling 600 to the bleed valve 200. In the illustrated embodiment, the first tube 602 and the key 604 of the male coupling 600 are received in the socket 328 of the bleed valve 200. The first section 610 of the first tube 602 is received in the first cylindrical bore 330 of the socket 328 of the bleed valve 200, and the second section 612 of the first tube 602 is received in the second cylindrical bore 332 of the socket 328 of the bleed valve 200. The key 604 is received in the keyed section 334 of the socket 328 of the bleed valve 200. When the male coupling 600 engages the bleed valve 200, the third fluid flow passageway 636 of the male coupling 600 is in fluid communication with the socket 328 and the second fluid flow passageway 322 of the bleed valve 200.

In the illustrated embodiment, the first O-ring 630 of the male coupling 600 forms a fluid seal between the first section 610 of the first tube 602 and the first cylindrical bore 330 of the socket 328 of the bleed valve 200. The second O-ring 634 of the male coupling 600 forms a fluid seal between the second section 612 of the first tube 602 and the second cylindrical bore 332 of the socket 628 of the bleed valve 200. Thus, when the bleed valve 200 is in an open position, as described in greater detail below, the first O-ring 630 and the second O-ring 634 prevent fluid in the socket 328 from flowing around and/or past the first tube 602. As a result, the male coupling 600 and the socket 328 of the bleed valve 200 cooperate to direct substantially all fluid flowing into the bleed valve 200 to flow into the third fluid flow passageway 636 of the male coupling 600.

In the illustrated embodiment, the non-cylindrical shape of the key 604 substantially corresponds to and/or matches the non-cylindrical shape of the keyed section 334. As a result, the key 604 rotatably locks the male coupling 600 to the bleed valve 200 while enabling the key 604 to translate or slide out of engagement with the keyed section 334. As used in this disclosure, a first component is rotatably locked to a second component when the components are engaged such that rotation of the first component rotates the second component. For example, when the key 604 engages the keyed section 334, rotation of the male coupling 600 about the longitudinal axis 642 rotates the bleed valve 200 via the threads 316, 408. Components that are rotatably locked may have rotational play or lost rotary motion between the components.

FIG. 14 illustrates the bleed valve 200 in a second or open position. In the illustrated embodiment, when the bleed valve 200 is received in the receptacle 224, rotation of the bleed valve 200 raises or lowers the bleed valve 200 relative to the housing 202 of the first caliper 124. For example, when the bleed valve 200 rotates relative to the housing 202, the threads 316 of the bleed valve 200 may slide along the threads 408 in the receptacle 224 of the housing 202 to raise or lower the bleed valve 200 relative to the housing 202.

Thus, in the illustrated embodiment, when the male coupling 600 engages the bleed valve 200, rotation of the male coupling 600 in a first direction (e.g., counterclockwise) rotates the bleed valve 200 to raise the bleed valve 200 from the closed position to the open position. Rotation of the male coupling 600 in a second direction (e.g., clockwise) opposite the first direction rotates the bleed valve 200 to lower the bleed valve 200 to the closed position. When the bleed valve 200 is in the open position, fluid from the brake system 120 flows out of the brake system 120 via the male coupling 300. An example fluid flow path of the fluid from the brake system 120 into the male coupling 600 is illustrated by arrow A and arrow B.

When the bleed valve 200 is in the open position, the nose 306 of the body 300 is spaced apart from the seat 400. As a result, the first fluid flow passageway 220 of the housing 202, the receptacle 224, the second fluid flow passageway 322 of the bleed valve 200, the socket 328 of the bleed valve 200, and the third fluid flow passageway 636 of the male coupling 600 are in fluid communication. For example, fluid in the first fluid flow passageway 220 flows from the first branch 226 into an annulus 700 defined by surfaces bounding the bore 404 of the receptacle 224 and the body 300 of the bleed valve 200. The fluid then flows into the second fluid flow passageway 322 of the bleed valve 200 via the first port 324 and the second port 326. The fluid flows from the second fluid flow passageway 322 into the socket 328, and the socket 328 and the male coupling 600 cooperate to direct the fluid into the third fluid flow passageway 636 of the male coupling 600.

In some embodiments, the hose 624 is coupled to the hose connector 608, and a vacuum or syringe is operatively coupled to the hose 624 to draw the fluid from the brake system 120 and into the hose 624 to facilitate bleeding of the brake system 120. After the brake system 120 is replenished with the fluid, the male coupling 600 is rotated in the second direction to rotate the bleed valve 200 to the lower and closed position. The male coupling 600 may then be decoupled or removed from the bleed valve 200 by sliding the first tube 602 and the key 604 along the longitudinal axis 312 of the bleed valve 200 to evacuate or remove the first tube 602 from the socket 328. In some embodiments, the syringe generates a vacuum while the male coupling 600 is being removed from the bleed valve 200 to draw any fluid in the socket 328 and the male coupling 600 into the hose 624 to prevent pooling of the fluid in the bleed valve 200 and/or leakage of the fluid from the male coupling 600 when the male coupling 600 is being removed from the bleed valve 200.

Numerous modifications to the embodiments disclosed herein will be apparent to those skilled in the art in view of the foregoing description. For example, any of the embodiments disclosed herein may be modified to include any of the structures or/or methodologies disclosed in connection with different embodiments. Accordingly, this disclosure is to be construed as illustrative only and is presented for the purpose of enabling those skilled in the art to make and use the invention and to teach the best mode of carrying out same. The exclusive rights to all modifications which come within the scope of the appended claims are reserved.

1. A bleed valve assembly, comprising:
a bleed valve having a first fluid flow passageway and a socket in fluid communication with the first fluid flow passageway; and
a male coupling comprising:
a first tube having a second fluid flow passageway, the first tube dimensioned to be received in the socket of the bleed valve to enable the second fluid flow passageway to be in fluid communication with the first fluid flow passageway; and
a key to be received in the socket to rotatably lock the male coupling to the bleed valve; and
a scaling member configured to form a fluid seal between the bleed valve and the male coupling.

2. The bleed valve assembly of claim 1, wherein the male coupling includes a hose connector having a second tube in fluid communication with the first tube.

3. The bleed valve assembly of claim 1, wherein the male coupling includes a knob.

4. The bleed valve assembly of claim 3, wherein the second fluid flow passageway extends through the knob.

5. The bleed valve assembly of claim 1, wherein the key is a hexagonal prism.

6. The bleed valve assembly of claim 1, wherein the socket includes a bore and a keyed section, the key to engage the keyed section to rotatably lock the male coupling to the bleed valve.

7. The bleed valve assembly of claim 6, wherein the keyed section includes a first planar wall and a second planar wall.

8. The bleed valve assembly of claim 1 further comprising a housing including a receptacle, the bleed valve received in the receptacle.

9. The bleed valve assembly of claim 8, wherein the housing includes an aerodynamic surface, and wherein an end of the bleed valve is substantially flush with the aerodynamic surface when the bleed valve is in a closed position.

10. A bleed valve, comprising:
an exterior surface;
a socket defining a space, the socket comprising a first bore, a second bore, and a keyed section disposed between the first bore and the second bore; and
a fluid flow passageway extending from the exterior surface to the space.

11. The bleed valve of claim 10, wherein the exterior surface includes a thread.

12. (canceled)

13. The bleed valve of claim 10, wherein the keyed section includes a planar wall.

14. The bleed valve of claim 10, wherein the keyed section is a non-cylindrical shaped female receptacle.

15. (canceled)

16. (canceled)

17. The bleed valve of claim 10, wherein the bleed valve includes a nose.

18. The bleed valve of claim 17, wherein the nose is provided on a second end of the bleed valve, and an opening of the socket is defined by a first end of the bleed valve opposite the second end.

19. The bleed valve of claim 10, wherein the fluid flow passageway passes through the bleed valve and intersects the socket.

20. The bleed valve of claim 19, wherein the exterior surface includes a first port and a second port of the fluid flow passageway.

21. A bleed valve assembly, comprising:
a housing including a receptacle and a first fluid flow passageway in fluid communication with the receptacle;
a bleed valve to be disposed in the receptacle and movably coupled to the housing, the bleed valve including a plug, a second fluid flow passageway, and a socket in fluid communication with the second fluid flow passageway; and
a sealing member configured to form a fluid seal between the housing and the bleed valve.

22. The bleed valve assembly of claim 21, wherein the bleed valve includes threads movably coupling the bleed valve to the housing.

23. The bleed valve assembly of claim 21, wherein the housing includes an aerodynamic surface, and wherein the bleed valve includes a first end at least one of substantially flush with or recessed relative to the aerodynamic surface.

24. The bleed valve assembly of claim 23, wherein the first end of the bleed valve defines an opening of the socket.

25. The bleed valve assembly of claim 21, wherein the socket includes a keyed section.

26. The bleed valve assembly of claim 25, wherein the keyed section is a polygonal shaped female receptacle.

27. The bleed valve assembly of claim 25, wherein the socket includes a first bore.

28. The bleed valve assembly of claim 27, wherein the socket includes a second bore, and wherein the keyed section is disposed between the first bore and the second bore.

29. The bleed valve assembly of claim 21, wherein the housing is for a bicycle component.

30. The bleed valve assembly of claim 29, wherein the bicycle component is a brake caliper.

31. The bleed valve assembly of claim 29, wherein the bleed valve includes threads movably coupling the bleed valve to the housing.

32. The bleed valve assembly of claim 29, wherein the housing includes an aerodynamic surface, and wherein the bleed valve includes a first end at least one of substantially flush with or recessed relative to the aerodynamic surface.

33. The bleed valve assembly of claim 32, wherein the first end of the bleed valve defines an opening of the socket.

34. The bleed valve assembly of claim 29, wherein the socket includes a keyed section.

35. The bleed valve assembly of claim 34, wherein the keyed section is a polygonal shaped female receptacle.

36. The bleed valve assembly of claim 35, wherein the socket includes a first bore.

37. The bleed valve assembly of claim 36, wherein the socket includes a second bore, and wherein the keyed section is disposed between the first bore and the second bore.

38. A bleed valve assembly, comprising:
a bleed valve including a socket and a first fluid flow passageway in fluid communication with the socket;
a male coupling including a second fluid flow passageway, first tube, a hose connector, and knob, wherein the first tube is to be received in the socket to fluidly couple the first fluid flow passageway and the second fluid flow passageway, wherein the male coupling is configured to form a fluid seal with the bleed valve.

39. The bleed valve assembly of claim 38, wherein the second fluid flow passageway extends through the first tube, the knob, and the hose connector.

40. The bleed valve assembly of claim 38, wherein the socket includes a keyed section, and the male coupling includes a key.

41. The bleed valve assembly of claim 40, wherein the keyed section is a non-cylindrical shaped female receptacle, and the key is shaped and dimensioned to mate with the keyed section.

42. The bleed valve assembly of claim 38, wherein the male coupling includes an O-ring to form a fluid seal between the male coupling and the bleed valve when the first tube is received in the socket.

43. The bleed valve assembly of claim 38, wherein the knob is disposed between the first tube and the hose connector.
